(19) United States
(12) Patent Application Publication
(10) Pub. No.: US 2024/0420513 A1
(43) Pub. Date: Dec. 19, 2024

(54) PSEUDONYMOUS LOGGING AND DIRECTIVES

(71) Applicant: Tesla, Inc., Austin, TX (US)

(72) Inventors: Ming Wood, San Jose, CA (US); Joe Kwiatkowski, Palo Alto, CA (US); Brian Stuart Boggs, Palo Alto, CA (US); Roshni Shah, Palo Alto, CA (US)

(21) Appl. No.: 18/701,797

(22) PCT Filed: Oct. 20, 2022
(86) PCT No.: PCT/US2022/047317

§ 371 Date: Apr. 16, 2024

Related U.S. Application Data
(60) Provisional application No. 63/262,864, filed on Oct. 21, 2021.

(51) Int. Cl. G07C 5/00

(52) U.S. Cl. CPC G07C 5/006; G07C 5/008

(57) ABSTRACT

The present disclosure related to a management of data communications between individual vehicles and a network service. The network service can facilitate the management of data communications between a selected vehicle and remote service utilizing pseudonymous identifiers. Illustratively, a pseudonymous identifier can correspond to at least a semi-unique identifier generated by a vehicle or configured on a vehicle. The generation/configuration of the pseudonymous is implemented in a manner that the network service does not associate any additional identifiers, such as VINs, associated with the vehicle, vehicle owner, vehicle user, etc. For example, the network service can identify vehicle directives associated with the pseudonymous identifiers based on processing the vehicle data. The vehicle can identify one or more directives by matching the pseudonymous identifiers with the vehicle's pseudonymous identifier.

### CROSS-REFERENCE TO RELATED APPLICATION

This application is a non-provisional of and claims priority to U.S. Provisional Patent Application No. 63/262,864, entitled “PSEUDONYMOUS LOGGING AND DIRECTIVES,” filed on Oct. 21, 2021, which is hereby incorporated by reference in its entirety and for all purposes.

### BACKGROUND

Generally described, computing devices and communication networks can be utilized to exchange data and/or information. In a common application, a computing device can request content from another computing device via the communication network. For example, a user at a personal computing device can utilize a browser application to request a content page (e.g., a network page, a Web page, etc.) from a server computing device via the network (e.g., the Internet). In such embodiments, the user computing device can be referred to as a client computing device and the server computing device can be referred to as a content provider. In another embodiment, the user computing device can collect or generate information and provide the collected information to a server computing device for further processing or analysis.

Generally described, a variety of vehicles, such as electric vehicles, combustion engine vehicles, hybrid vehicles, etc., can be configured to collect information regarding the vehicle. In certain scenarios, a service provider may wish to access operation parameters, sensor values, or other information associated with a vehicle, such as to monitor or calculate vehicle performance characteristics. In other scenarios, a service provider may wish to contact one or more vehicle users or owners to request the implementation of an action.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of an illustrative environment for providing vehicle communication with a network service in accordance with one or more aspects of the present application;

FIG. 2 depicts a block diagram of an illustrative environment that corresponds to vehicles in accordance with one or more aspects of the present application;

FIG. 3A depicts an illustrative architecture for implementing a management component in accordance with aspects of the present application;

FIG. 3B depicts an illustrative architecture for implementing a vehicle data service in accordance with aspects of the present application:

FIG. 4 is a block diagram of an illustrative environment of interactions between the network service and an individual vehicle for the creation of pseudonyms according to an embodiment:

FIG. 5 is a block diagram of an illustrative environment of interaction between the network service and an individual vehicle for transmission of vehicle data based on one or more pseudonymous identifiers according to an embodiment;

FIG. 6 is a block diagram of the illustrative environment of interaction between the network service and an individual vehicle for transmission of vehicle directives according to an embodiment;

FIG. 7 is a block diagram of the illustrative environment of the interaction of an alternative embodiment between the network service 120 and a computing device 130 for transmission of vehicle directives;

FIG. 8 is a flow chart describing a routine for a vehicle pseudonym management according to one or more embodiments as disclosed herein;

FIG. 9 is a flow chart describing a routine for a vehicle data transmission according to one or more embodiments as disclosed herein;

FIG. 10 is a flow chart describing a routine for a vehicle directive request processing according to one or more embodiments as disclosed herein;

FIG. 11 is a flow chart describing a routine for a vehicle directive request processing according to one or more embodiments as disclosed herein.

### DETAILED DESCRIPTION

Generally described, one or more aspects of the present disclosure relates to the configuration and management of data provided by vehicles or actions implemented by vehicles. By way of an illustrative example, aspects of the present application correspond to the management of data communications between individual vehicles and a network service. Illustratively, vehicle data can include, but is not limited to, vehicle operational information, vehicle parameters, sensor configuration information, sensor values, environmental information, and the like. In other illustrative examples, aspects of the present application correspond to the management of actions or directives implemented by a select subset of vehicles based on communications generated by a network service.

Generally described, access to vehicle information has generally been limited to applications in which vehicle data and vehicles are associated with identifying information unique to an individual or vehicle. For example, a plurality of services are able to track vehicle ownership, vehicle performance data, vehicle maintenance information, etc., according to a unique identifier, as the Vehicle Identification Number (“VIN”) assigned to the vehicle at manufacture Traditionally, VIN numbers for vehicles are also associated with the individual information of registered owners. Accordingly, in such implementations, a close association of VIN numbers to a vehicle is required such that a service provider receiving vehicle data associated with a VIN is able to closely associate all received operational and performance data to an individual user. Accordingly, utilization of VIN numbers with vehicle data reporting and processing does not provide for privacy protection because the VIN is known to both the service provider and the vehicle and is further associated with an owner. Such systems/approaches may be vulnerable to manipulation or security breaches.

To address at least a portion of the above-identified inefficiencies, a network service can facilitate the management of data communications between a selected vehicle and remote service utilizing pseudonymous identifiers. Illustratively, a pseudonymous identifier can correspond to at least a semi-unique identifier generated by a vehicle or configured on a vehicle. The generation/configuration of the pseudonymous is implemented in a manner that the network service does not associate any additional identifiers, such as VINs, associated with the vehicle, vehicle owner, vehicle user, etc. In this regard, individual pseudonymous identifiers represent a logical, generic identifier for individual vehicles that may be transmitted and processed without association with any vehicle identification or user identification information.

A vehicle can include network communications functionality that can establish bi-directional communications with the network service. In some embodiments, the individual vehicles generate/configure the pseudonymous identifier(s) and register the generated pseudonymous identifiers with the network service. Thereafter, vehicles can collect and transmit vehicle data (e.g., performance metrics, operational status, sensor values, etc.) associated with the pseudonymous identifiers. The network service in return can receive the vehicle data for a plurality of vehicles without identifying any particular source of a vehicle data (e.g., a specific VIN or other identifier) other than a pseudonymous identifier. The network service can then make the collected vehicle data available for processing, such as diagnostic processing, use processing, and the like.

In certain embodiments, a user of the network service may wish to elicit some action to be implemented by selected vehicles satisfying selection criteria corresponding to the collected vehicle data. For example, the network service may receive an action request that attempts to elicit a service request or execution of a diagnostic/corrective process for vehicles satisfying selection criteria. In another example, the network service may receive an action request that attempts to provide a notification to users/owners of vehicles satisfying selection criteria. The network service cannot directly transmit communications to the target vehicles, such as via a direct communication, because the collected data satisfying the selection criteria is only associated with the pseudonymous identifier. Accordingly, the network service can publish a vehicle directive that corresponds to a list of pseudonyms that are requested to implement some responsive action.

In some embodiments, the vehicle can be configured to periodically synchronize the vehicle data with a computing device, such as a personal mobile device. In these embodiments, the vehicle and computing device can be configured to establish bi-directional communications to transmit/receive the vehicle data. The computing device also can include network communications functionality that can establish bi-directional communications with the network service. In these embodiments, the computing device can be configured to collect and transmit the vehicle data associated with the pseudonymous identifier. The computing device can also identify the pseudonymous identifier associated with a vehicle and receive one or more directives from the network service.

In certain embodiments, the computing device can be configured to communicate with the network service as a secondary network. For example, if the communication between the vehicle and the network service is severed or disrupted, the computing device can establish a secondary communication channel with the network service and continue to communicate with the network service. In these embodiments, the computing device may perform synchronization with the vehicle in real-time or after the computing device completes the communication with the network service. Thus, utilizing the computing device can increase the network durability or reliability between the vehicle and network service.

In certain embodiments, both the vehicle and computing device may provide a response to one or more directives generated from the network service. In these embodiments, the vehicle or computing device that transmits a first response signal to the network service will have a priority in communicating with the network service. For example, if the network service receives a response signal from the computing device before receiving it from the vehicle, the network service may communicate with the computing device.

Thereafter, individual vehicles are configured to poll the published vehicle directive list by pseudonym and determine whether any of the listed pseudonyms match the individual vehicle's pseudonym. If so, the vehicle can cause the implementation of responsive action. For example, the vehicle can implement the requested diagnostic action or error correction. In another example, the vehicle can generate further communications to the network service with additional information or request additional instructions. The additional information or transmission may omit the pseudonym identifier so that the network service cannot correlate the matching pseudonym identifier to the additional transmission. Illustratively, in some embodiments, the published list of pseudonyms is of a sufficient scale such that responsive actions, including VINs or other identification information, cannot be directly tied to the incoming responses.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicle data or vehicle processes. However, one skilled in the relevant art will appreciate that the aspects of the present application are not necessarily limited to application to any particular type of vehicle data, data communications or illustrative interaction between vehicles, owners/users, and a network service. Such interactions should not be construed as limiting.

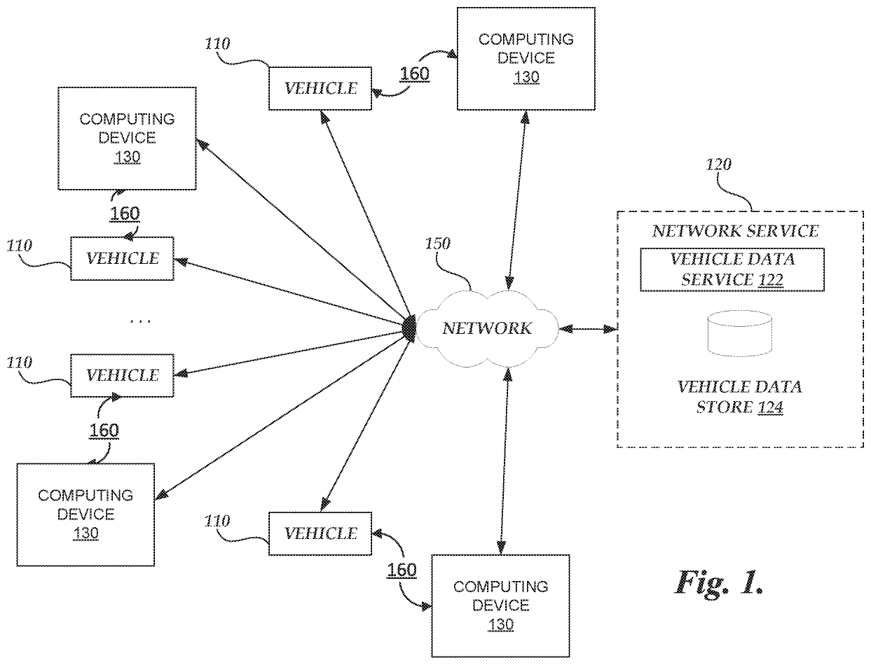

FIG. 1 depicts a block diagram of an illustrative environment of a system 100 that a plurality of vehicles communicate with a network service via a network connection. The system 100 can comprise a network, the network connecting a set of vehicles 110, a network service 120, and computing devices 130. The components may correspond to software modules implemented or executed by one or more external computing devices, which may be separate stand-alone external computing devices. Accordingly, the components of the network service 120 should be considered as a logical representation of the service, not requiring any specific implementation on one or more external computing devices.

Network 150, as depicted in FIG. 1 can connect the devices and modules of the system. The network can connect any number of devices. In some embodiments, the vehicles 110, the network service 120, and the computing devices 130 can communicate or exchange data (e.g., the establishment of one or more communication channels) via the network 150. In some embodiments, the network service 120 provides network-based services to the vehicles 110, and the computing devices 130 via the network 150. The network service 120 can implement network-based services and refers to a large, shared pool of network-accessible computing resources (such as compute, storage, or networking resources, applications, or services), which may be virtualized or bare-metal. The network service 120 can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service that provides those services.

In some embodiments, the network 150 can be secured networks, such as a local area network that communicates securely via the Internet with the network service 120. The network 150 may include any wired network, wireless network, or combination thereof. For example, the network 150 may be a personal area network, local area network, wide area network, over-the-air broadcast network (e.g., for radio or television), cable network, satellite network, cellular telephone network, or combination thereof. As a further example, the network 150 may be a publicly accessible network of linked networks, possibly operated by various distinct parties, such as the Internet. In some embodiments, the network 150 may be a private or semi-private network, such as a corporate or university intranet. The network 150 may include one or more wireless networks, such as a Global System for Mobile Communications (GSM) network, a Code Division Multiple Access (CDMA) network, a Long Term Evolution (LTE) network, a 5G (5 generation wireless communication), or any other type of wireless network. The network 150 can use protocols and components for communicating via the Internet or any of the other aforementioned types of networks. For example, the protocols used by the network 150 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In some embodiments, each individual of the vehicles 110 is connected with a computing device 130 and a network 160. In these embodiments, the network 160 comprises any combination of wired and/or wireless networks, such as one or more direct communication channels, local area network, wide area network, personal area network, and/or the Internet, for example. In some embodiments, the communication between the vehicles 110 and the computing devices 130 may be performed via a short-range communication protocol, such as Bluetooth, Bluetooth low energy (“BLE”), and/or near field communications (“NFC”). In some embodiments, the network 160 can be utilized as a backup network for the network 150. For example, when the communication between the vehicle 110 and the network service 120 is severed or disrupted, the communication can be performed by utilizing a network between computing device 130 and network service 120. In some embodiments, the vehicle data can be periodically synchronized by utilizing the network 160. In certain embodiments, each computing device 130 can establish the network 160 with more than one of the vehicles 110.

In some embodiments, the networks 150, 160 may include some or all of the same communication protocols, services, hardware, etc. Thus, although the discussion herein may describe communication between the vehicles 110 and the computing devices 140 via the network 160 and communication between the vehicles 110, the network service 120, the third party service providers 130, and the computing devices 140 can occur via the network 150, communications of the devices and/or the network bases services are not limited in this manner. The various communication protocols discussed herein are merely examples, and the present application is not limited thereto.

In some embodiments, the computing device 130 (e.g., also referred to as a user device) can be any computing device such as a desktop, laptop or tablet computer, personal computer, tablet computer, wearable computer, server, personal digital assistant (PDA), hybrid PDA/mobile phone, mobile phone, smartphone, set top box, voice command device, digital media player, and the like. In some embodiments, the computing device 130 may execute an application (e.g., a browser, a stand-alone application, etc.) that allows a user to access interactive user interfaces, view images, analyses, or aggregated data, and/or the like as described herein. In various embodiments, the users of the computing devices 130 may interact with the vehicle and/or network service via various devices. Such interactions may typically be accomplished via interactive graphical user interfaces or voice commands, however, alternatively such interactions may be accomplished via command line, and/or other means.

Illustratively, the network service 120 can include a vehicle data service 122 that can provide functionality responsive to data received from the vehicles 110 and/or computing devices 130 as applied to aspects of the present application. In some embodiments, the vehicle periodically transmits the vehicle data with pseudonymous identifier(s) associated with particular vehicle to the vehicle data service 122. In these embodiments, the vehicle data service 122 can process the vehicle data received from the vehicles and provide directives. For example, the vehicle data service 122 receives the vehicle data from a plurality of vehicles 110, where each vehicle is associated with a pseudonymous identifier. Then, the vehicle data service 122 processes the vehicle data and posts directives with the pseudonymous identifier for each directive. The network service 120 may further include a vehicle data store 124 configured to store the processed data and/or received vehicle data from the plurality of data. The network service is represented in a simplified, logical form and does not reflect all of the physical software and hardware components that may be implemented to provide the functionality associated with the network service.

Each of the vehicles 110 can include communication functionality, including hardware and software, that facilitate interaction via one of a plurality of communication mediums and communication protocols. More specifically, the vehicles include a plurality of sensors, components, and data stores for obtaining, generating, and maintaining vehicle data, including operational data. In some embodiments, the information provided by the components can include processed information in which a controller, logic unit, processor, and the like has processed sensor information and generated additional information, such as a vision system that can utilize inputs from one or more camera sensors and provide outputs (e.g., processing of raw camera image data and the generation of outputs corresponding to the processing of the raw camera image information). The camera sensor may be the sensor component that is associated with vision systems for determining vehicle operational status, environmental status or other information. In other embodiments, the camera sensors can be separate from the sensor components, such as for non-camera sensor components or vehicles having multiple camera sensors. In still another example, a control component can utilize additional information obtained from, or otherwise associated with, positioning systems, calendaring systems, or time-based systems.

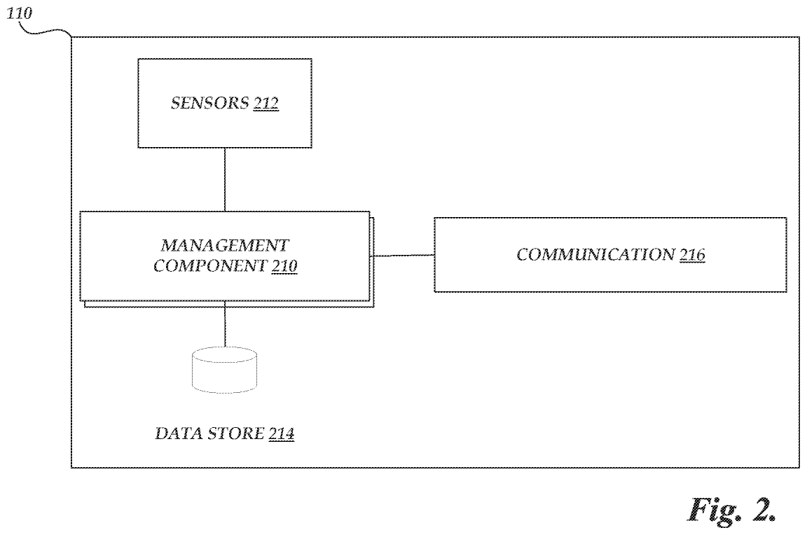

For purposes of illustration, FIG. 2 illustrates an environment that corresponds to vehicles 110 in accordance with one or more aspects of the present application. Individual vehicles illustratively include a management component 210 that is operable to implement one or more aspects of the present application as described herein. In one aspect, the management component 210 can generate or configure pseudonymous identifier(s) that will be utilized to identify the vehicle by the network service. The pseudonymous identifier can correspond to any one of a variety of unique or semi-unique identifiers. The pseudonymous identifier may be based on attributes of the vehicle, such as representation of specific hardware or software components. In another example, a pseudonymous identifier may be selected from a list of available pseudonymous identifiers, such as random selection. The generation or configuration of the pseudonymous identifier(s) may take place at time of manufacture, release from the manufacturer, and the like. For purposes of simplicity, one or more vehicles are represented generally as a single component, but would include some portion of the functionality described and illustrated with other vehicles.

The environment of the vehicles 110 can include sensors 212 that can provide inputs for the operation of the vehicle or collection of information as described herein. The collection of sensors 212 can include one or more sensor or sensor-based systems included with a vehicle or otherwise accessible by a vehicle during operation. The sensors 212 may be integrated into the vehicle. Alternatively, the sensors 212 may be provided by interfaces associated with a vehicle, such as physical connections, wireless connections, or a combination thereof.

In one aspect, the sensors 212 can include vision systems that provide inputs to the vehicle, such as detection of objects, attributes of detected objects (e.g., position, velocity, acceleration), presence of environment conditions (e.g., snow, rain, ice, fog, smoke, etc.), and the like. For example, the vehicles 110 may each include a plurality of sensors 212 (including cameras, operational sensors, etc.), a management component 210, and data store 214. In this example, the sensors 212 may provide the vehicle operational parameters to the management component 210 in real time or near real time. The management component 210 may provide data related to controlling the vehicle, such as steering wheel direction, acceleration, braking, etc. The data store 214 may store information related to the current vehicle operational environment. In some embodiments, vehicles 110 can rely on such vision systems for defined vehicle operational functions without assistance from or in place of other traditional detection systems.

In yet another aspect, the sensors 212 can further include one or more positioning systems that can obtain reference information from external sources that allow for various levels of accuracy in determining positioning information for a vehicle. For example, positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specific elevation at a current location. In other embodiments, the positioning systems can also determine travel-related operational parameters, such as the direction of travel, velocity, acceleration, and the like. The positioning system may be configured as part of a vehicle for multiple purposes, including self-driving applications, enhanced driving or user-assisted navigation, and the like. Illustratively, the positioning systems can include processing components and data that facilitate the identification of various vehicle parameters or process information.

In still another aspect, the sensors 212 can include one or more navigations system for identifying navigation related information. Illustratively, the navigation systems can obtain positioning information from positioning systems and identify characteristics or information about the identified location, such as elevation, road grade, etc. The navigation systems can also identify suggested or intended lane locations in a multi-lane road based on directions that are being provided or anticipated for a vehicle user. Similar to the location systems, the navigation system may be configured as part of a vehicle for multiple purposes, including self-driving applications, enhanced driving or user-assisted navigation, and the like.

The local resources further include one or more management component(s) 210 that may be hosted on each of the vehicles 110 or a computing device 130 accessible by a vehicle (e.g., a mobile computing device). The management component(s) 210 can illustratively access inputs from various sensors 212 and process the inputted data and store the processed data. For purposes of the present application, the management component(s) 210 will be described with regard to one or more functions related to illustrative aspects. For example, the management component 210 may generate or configure the pseudonymous identifier by associating with the vehicle data generated from the plurality of sensors 212. The management component 210 may communicate with the computing device 130 and network service 120 via the communication 216.

The environment can further include various additional sensor components or sensing systems operable to provide information regarding various operational parameters for use in accordance with one or more of the operational states. The environment can further include one or more control components for processing outputs, such as the transmission of data through a communications output, the generation of data in memory, the transmission of outputs to other processing components, and the like.

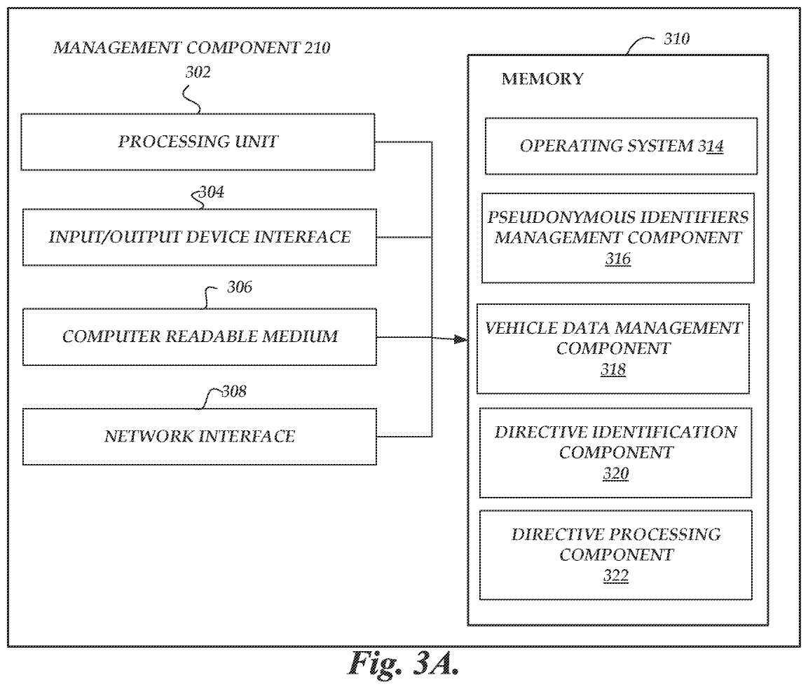

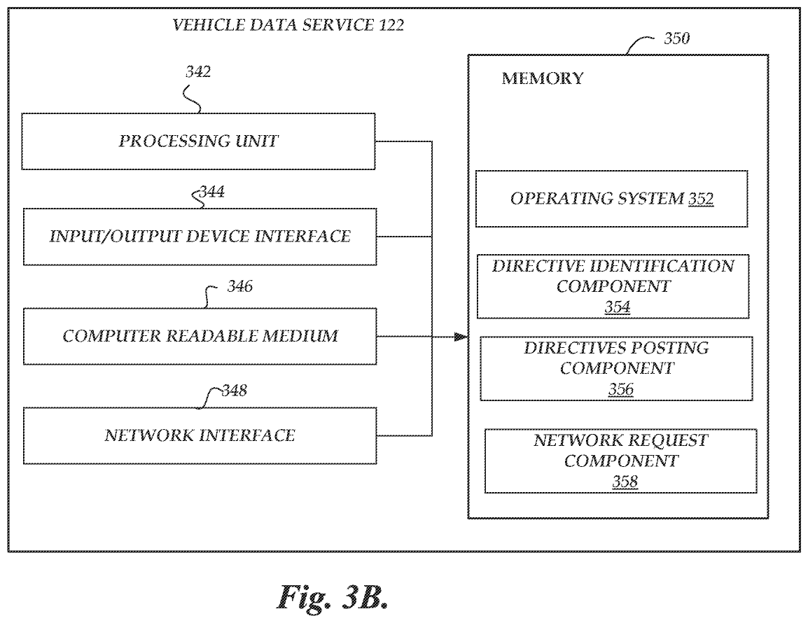

With reference now to FIG. 3A, an illustrative architecture for implementing the management component 210 on the vehicles 110 will be described. The management component 210 may be part of components/systems that can provide functionality associated with generating or configuring the pseudonymous identifier(s) and processing and managing the vehicle data to be further used in the network service. The management component 210 may further configured to identify directives generated from the network service and perform one or more corrective actions based on the directive.

The architecture of FIG. 3A is illustrative in nature and should not be construed as requiring any specific hardware or software configuration for the management component 210. The general architecture of the management component 210 is depicted in FIG. 3A includes an arrangement of computer hardware and software components that may be used to implement aspects of the present disclosure. As illustrated, the management component 210 can include a processing unit 302, a network interface 308, a computer readable medium drive 306, and an input/output device interface 304, all of which may communicate with one another by way of a communication bus. The components of the management component 210 may be physical hardware components that can include one or more circuitries and software models.

The network interface 308 may provide connectivity to one or more networks or computing systems, such as the networks 150, 160 of FIG. 1. The processing unit 302 may thus receive information and instructions from other computing systems or services via a network. The processing unit 302 may also communicate to and from memory 310 and further provide output information via the input/output device interface. In some embodiments, the management component 210 may include more (or fewer) components than those shown in FIG. 3A.

The memory 310 may include computer program instructions that the processing unit 302 executes in order to implement one or more embodiments. The memory 310 generally includes RAM, ROM, or other persistent or non-transitory memory. The memory 310 may store an operating system 314 that provides computer program instructions for use by the processing unit 302 in the general administration and operation of the management component 210. The memory 310 may further include computer program instructions and other information for implementing aspects of the present disclosure.

The memory 310 may include pseudonymous identifier(s) management component 316. The pseudonymous identifier(s) management component 316 can be configured to generate or configure the pseudonymous identifier(s) by associating with the vehicle data. The individual pseudonymous identifiers represent a logical, generic identifier for individual vehicles that may be transmitted and processed without association with any vehicle identification or user identification information. The pseudonymous identifier can correspond to any one of a variety of unique or semi-unique identifier. The pseudonymous identifier may be based on attributes of the vehicle, such as representation of specific hardware or software components. In another example, a pseudonymous identifier may be selected from a list of available pseudonymous identifiers, such as random selection. The generation or configuration of the pseudonymous identifier(s) may take place at time of manufacture, release from the manufacturer, and the like. The pseudonymous identifies may be associated with encryption mechanisms or other security mechanism to prevent modification or corruption of the pseudonymous identifier by a user or external service.

In some embodiments, the pseudonymous identifier(s) management component 316 process the vehicle data by adding the pseudonymous identifier corresponding to the vehicle. For example, the pseudonymous identifier(s) management component 316 may add the pseudonymous identifier for each segment of the vehicle data or group of the vehicle data In one embodiment, the pseudonymous identifier(s) is automatically added to the vehicle data, when the vehicle transmits the vehicle data to network service. In some embodiments, the pseudonymous identifier(s) management component 316 may generate a new pseudonymous identifier(s) associated with the vehicle. For example, a vehicle manufacturer, administrators, or owner may request to replace the pseudonymous identifier(s) with a new identifier(s). For example, if the existing pseudonymous identifier(s) information is released to the public, the vehicle owner may request to reset the pseudonymous identifier(s). In this example, the pseudonymous identifier(s) management component 316 may generate a new identifier or receive a new identifier from the vehicle manufacturer (e.g., the vehicle manufacturer's authorized service facility, technician, or administrators). In these embodiments, the pseudonymous identifier(s) management component 316 may keep track of the previous pseudonymous identifier(s) by associating the identifier(s) to the new pseudonymous identifier(s).

In some embodiments, the pseudonymous identifier(s) management component 316 may identify any vehicle activity (e.g., service activity) performed with the vehicle's VIN number. For example, if a vehicle changes a brake fluid and the brake fluid record is stored with the vehicle's VIN number, the pseudonymous identifier(s) management component 316 may associate the brake fluid history with the pseudonymous identifier(s) of the vehicle. In this example, the pseudonymous identifier(s) management component 316 may identify the vehicle activity based on searching a public record of the vehicle's VIN. In some embodiments, the pseudonymous identifier(s) management component 316 may associate the pseudonymous identifier(s) with one or more vehicle service requests, history, or parts. For example, if the vehicle ordered a new part, the pseudonymous identifier(s) management component 316 may associate the new part with the vehicle's pseudonymous identifier(s). The type or number of vehicle activity or service is not limited by this present disclosure.

The memory 310 may further include a vehicle data management component 318. In some embodiments, the vehicle data management component 318 can collect vehicle data. The vehicle data can include but is not limited to the vehicle's performance metrics, operational status, sensor values, location information, etc. As described in FIG. 2, the vehicles include a plurality of sensors, components, and data stores for obtaining, generating and maintaining vehicle data, including operational data. The collection and processing of vehicle data may be based on programed configuration data, manual input from a user, or responsive to requests from the network service.

The memory 310 may further include a directive identification component 320. The directive identification component 320 can be configured to identify one or more directives issued by the network service. The directives can include commands that need to be executed by the vehicle in response, such as diagnostic, repair, or updating processes. In some embodiments, the directive identification component 320 can collect and process the published/posted vehicle directives. In some embodiments, the directive identification component 320 may identify directives corresponding to the vehicle by attempting to match the vehicle's specific pseudonymous identifier with any of the pseudonymous identifiers associated with the vehicle directive. If the directive identification component 320 does not match the vehicle's specific pseudonymous identifier, the vehicle directive can be disregarded.

The memory 310 may further include a directive processing component 322. The directive processing component 322 can process the published/posted vehicle directives associated with the pseudonymous identifiers of the vehicle. In some embodiments, processing the vehicle directive can elicit a number of responsive actions by the vehicle. In one aspect, directives can include commands that are executed by the vehicle in response, such as diagnostic, repair or updating processes. The one or more actions may be considered mandatory or optional. In another aspect, the vehicle directives can include requests to elicit behavior by a vehicle owner/user, such as the generation of notification for scheduling a service call. Still, further, the vehicle can also transmit confirmations, status, or notifications as requested or if the vehicle is preconfigured to transmit confirmation, status or notification communications. In some embodiments, the directive processing component 322 by processing the directives, categorizes the directives based on priority, type of required action (e.g., mandatory, optional, urgent, etc.), etc. The directive processing component 322 may further provide one or more instructions or recommendations to the vehicle owner or driver based on the processing result of the directives.

With reference now to FIG. 3B, an illustrative architecture for implementing the vehicle data service 122 on a network service 120 will be described. The vehicle data service 122 may be part of components/systems that can provide functionality associated with the vehicle 110 and/or computing devices 130. The vehicle data service 122 can be configured to receive the vehicle data periodically and issue the vehicle directives based on processing the vehicle data. Based on the processing result of the vehicle data, the vehicle data service 122 can be configured to post the vehicle directives with the list of pseudonym identifiers.

The architecture of FIG. 3B is illustrative in nature and should not be construed as requiring any specific hardware or software configuration for the vehicle data service 122. The general architecture of the vehicle data service 122 is depicted in FIG. 3B includes an arrangement of computer hardware and software components that may be used to implement aspects of the present disclosure. As illustrated, the vehicle data service 122 includes a processing unit 342, a network interface 348, a computer readable medium drive 346, and an input/output device interface 344, all of which may communicate with one another by way of a communication bus. The components of the vehicle data service 122 may be physical hardware components that can include one or more circuitries and software models.

The network interface 348 may provide connectivity to one or more networks or computing systems, such as the networks 150, 160 of FIG. 1. The computing device 140 may thus receive information and instructions from other computing systems or services via a network. The vehicle data service 122 may also communicate to and from memory 350 and further provide output information via the input/output device interface. In some embodiments, the vehicle data service 122 may include more (or fewer) components than those shown in FIG. 3B.

The memory 350 may include computer program instructions that the processing unit 342 executes in order to implement one or more embodiments. The memory 350 generally includes RAM, ROM, or other persistent or non-transitory memory. The memory 350 may store an operating system 352 that provides computer program instructions for use by the processing unit 342 in the general administration and operation of the vehicle data service 122.

The memory 350 can include a directive identification component 354. The directive identification component 354 may receive a request for issuance of a vehicle directive by pseudonym. Illustratively, a vehicle directive corresponds to one or more actions and associated parameters that will be elicited by the directive identification component 354 upon receipt. In one aspect, the directives can include commands that are executed by the vehicle in response, such as diagnostic, repair, or updating processes. The one or more actions may be considered mandatory or optional. In another aspect, vehicle directives can include requests to elicit behavior by a vehicle owner/user, such as the generation of notifications for scheduling a service call.

In some embodiments, the directive identification component 354 processes the vehicle directive request. In one aspect, the directive identification component 354 can validate that the request for vehicle data is permitted, such as via authentication or authorization mechanisms. In another aspect, the received request may not explicitly identify the pseudonymous identifiers of interest but provides selection criteria (e.g., all vehicles having a mileage exceeding 100,000 miles). Accordingly, the directive identification component 354 can query the stored vehicle data to identify the appropriate pseudonymous identifiers correlated to the selection criteria. In still another aspect, if selection criteria results in a set of pseudonymous identifiers that do not exceed a size threshold, the network service can reject the request, ask for additional criteria, or include additional pseudonymous identifiers to the set. As described previously, having a set of pseudonymous identifiers exceeding one or more thresholds can mitigate the potential network service, individual or third party can iteratively match a VIN or other identification information with a specific pseudonymous identifier.

The memory 350 can further include the directives posting component 356. The directives posting component 356 can post the vehicle directive request that identifies a set of pseudonymous identifiers that have been requested to implement the directive request. In some embodiments, the directives posting component 356 does not need to actively transmit the vehicle directive requests to each vehicle or include processing mechanisms that specifically identify contact mechanism (e.g., network addresses) for each pseudonymous identifier. Rather, individual vehicles will independently contact the network service for the published list of pseudonymous identifiers and vehicle directives.

In some embodiments, the directives posting component 356 posts vehicle directives with the list of pseudonym identifiers. Illustratively, the individual vehicles do not need to be configured to transmit the request at the same time. The transmission of the request can be randomized or implemented with a range of times (e.g., anytime throughout a day) such that the transmission of requests can be distributed in a manner to lessen the requirements for network processing resources by the network service. In one embodiment, the directives posting component 356 can provide the published/posted vehicle directives and associated set of pseudonymous identifiers. This can include an identification of the full list of pseudonymous identifiers or some sorted/filtered subset of pseudonymous identifiers. This approach requires the vehicle to be able to match a pseudonymous identifier with the list of pseudonymous identifiers. In another embodiment, the vehicle may transmit the pseudonymous identifier(s) of interest, and the directives posting component 356 can then determine whether a match occurs. The network service can then respond with a notification or confirmation. This embodiment can minimize the amount of data transmitted between the network service and the vehicle. Additionally, aspects of this embodiment can also reduce the impact on the vehicle's processing resources to process a list to identify potential matches.

The memory 350 can further include a network request component 358. The network request component 358 can collect network performance information, such as the network bandwidth, or by predefined rules in accessing vehicle data, such as predefined bi-directional data communication protocol. In some embodiments, the network request component 358 may identify the timing of initiating a communication with a vehicle. The timing of initiating the communication can be the timing of requests for vehicle data from the vehicle. In some embodiments, the network request component 358 may monitor network performance information to determine the timing of initiating requests for vehicle data, what vehicle data is requested, and the like. For example, the network request component 358 may utilize the collected network performance information to determine when vehicle data requests may be initiated. In another example, the network request component 358 may utilize network performance information to select or filter between different requested information during times of lower quality (relative) network conditions, such as selecting higher priority information. In a further example, the network request component 358 may implement different timing or spacing for data transmission in scenarios in which the network conditions are experiencing higher variability in quality or may be characterized as experiencing deteriorating conditions Illustratively, network performance information can include, but is not limited to, available bandwidth, latency measurements, transmission error rates, and the like.

In some embodiments, the network request component 358, in response to detecting that the network performance degradation, may configure a secondary network communication path with the computing device 130. For example, the vehicle and the network service may initially communicate via the network 150. In this example, if the network request component 358 detects that the vehicles 110 have a network connection severance or disruption, the network request component 358 may automatically connect to the computing device 130 associated with the vehicles 110.

In some embodiments, the network request component 358 can determine an initial communication path between the vehicle and network service or between the computing device and the network service. For example, the network request component 358 may establish an initial communication path with one of the computing device and the vehicle based on criteria. The criteria can be based on the timing of response received at the network request component 358. For example, if the network request component 358 receives a response from the vehicle before the computing device, the network request component 358 may establish the initial communication path between the vehicle and the network service. The criteria also can be based on network performance monitoring results. For example, the network request component 358 may compare the network performances of the network connection with the vehicle and computing device.

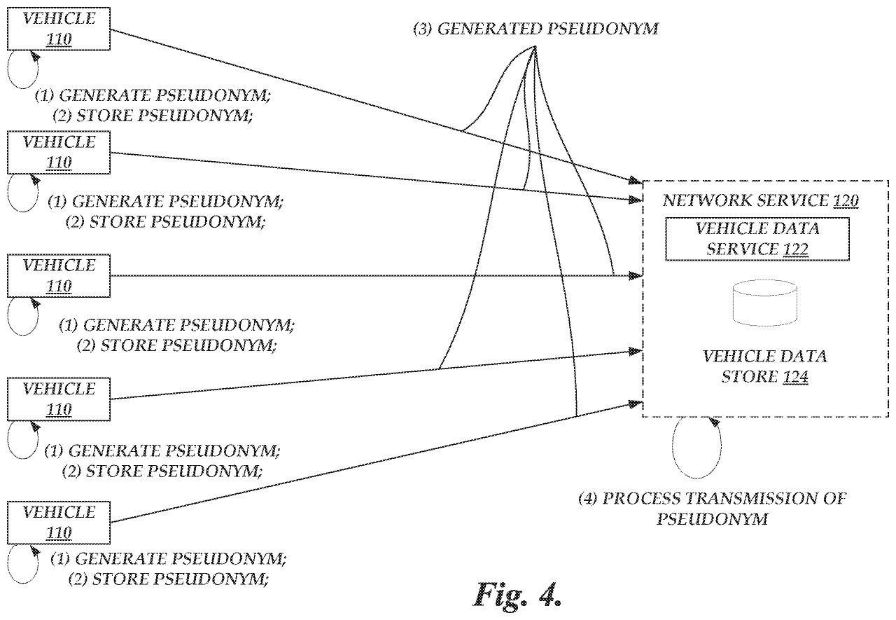

With reference now to FIG. 4, an illustrative interaction between the network service and an individual vehicle for the creation of pseudonyms will be described. Although a set of interactions are illustrated, the present application is not limited to any particular number of vehicles interacting with the network service. Rather, in some embodiments, the number of interactions between individual vehicles and the network service will be a relatively large scale including and exceeding thousands of individual vehicles.

At (1), the vehicles 110 (such as via a management component 210) can generate or configure pseudonymous identifier(s) that will be utilized to identify each of the vehicles 110 by the network service 120. As described above, the pseudonymous identifier can correspond to any one of a variety of unique or semi-unique identifiers. The pseudonymous identifier may be based on attributes of the vehicles 110, such as representation of specific hardware or software components. In another example, a pseudonymous identifier may be selected from a list of available pseudonymous identifiers, such as random selection. The generation or configuration of the pseudonymous identifier(s) may take place at time of manufacture, release from the manufacturer, and the like.

At (2), the vehicles 110 can store the pseudonymous identifiers in a local memory for use in communications. The pseudonymous identifies may be associated with encryption mechanisms or other security mechanism to prevent modification or corruption of the pseudonymous identifier by a user or external service.

At (3), the individual vehicles 110 can transmit pseudonym registrations with the network service 120 (such as vehicle data service 122). This process illustrates the first instantiation of the transmission of pseudonymous identifiers between the vehicles 110 and the network service 120. Although the transmissions are illustrated as being transmitted in parallel, one of the vehicles 110 may be triggered to register with the network service 120 at various times or in response to triggering criteria, such as the delivery of the vehicle to a new owner. In some embodiments, the timing of transmission of the pseudonym may be based on a seed value, such as a randomly generated number, so that the transmission of the pseudonyms does not closely relate to the delivery of the vehicle or timing of the generation of the pseudonym.

At (4), the network service 120 process the registration data with the pseudonymous identifier. Illustratively, the network service 120 can instantiate one or more records, data stores, etc. based solely on the transmitted pseudonymous identifier and without further association with other identification information associated with the vehicle, such as a VIN or user identifiers.

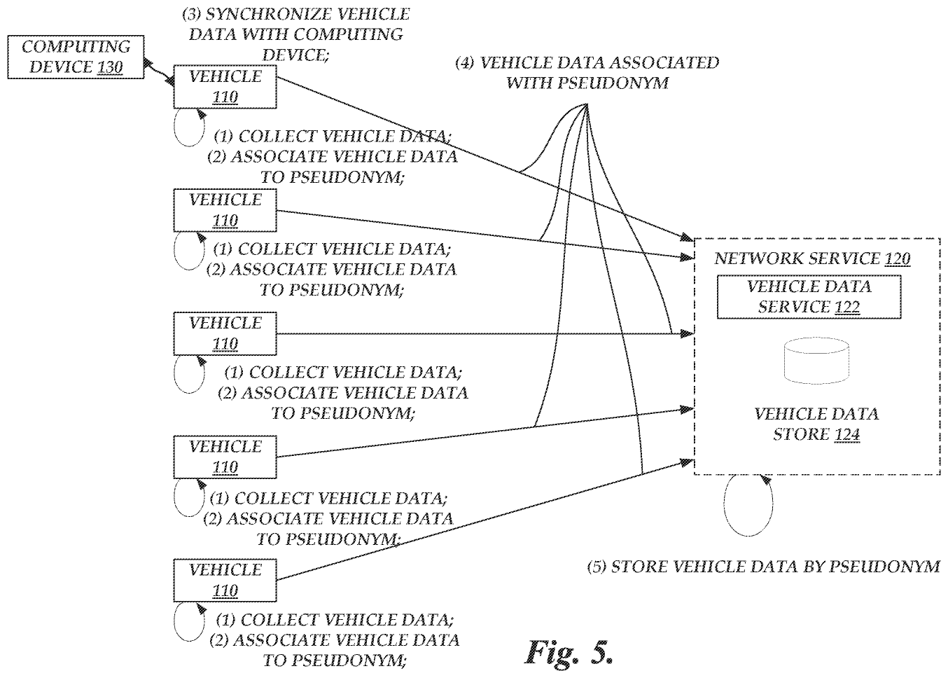

Turning now to FIG. 5, an illustrative interaction between the network service 120 and an individual one of the vehicles 110 for transmission of vehicle data based on one or more pseudonymous identifiers will be described. As described above, although a set of interactions are illustrated, the present application is not limited to any particular number of vehicles 110 interacting with the network service. Rather, in some embodiments, the number of interactions between individual vehicles and the network service 120 will be a relatively large scale including and exceeding thousands of individual vehicles 110.

At (1), the vehicles 110 (such as via a management component 210) can collect vehicle data. As described above, the vehicles include a plurality of sensors, components, and data stores for obtaining, generating, and maintaining vehicle data, including operational data. The collection and processing of vehicle data may be based on programed configuration data, manual input from a user, or responsive to requests from the network service (not illustrated).

At (2), the vehicles 110 can associate the previously stored pseudonymous identifiers maintained in local memory. The pseudonymous identifies and vehicle data may be associated with encryption mechanisms or other security mechanisms to prevent modification or corruption of the pseudonymous identifier by a user or external service.

At (3), one or more of the vehicles 110 may synchronize the vehicle data with the computing device 130. In some embodiments, the synchronization can be performed periodically or in real time. In some embodiments, a part of data can be synchronized with the computing device 130. In these embodiments, the part of data can be defined or designated by a user, vehicle manufacturer, vehicle administrator, etc. For example, the computing device 130 only get synchronized vehicle data related to engine oil management data. In this example, the computing device 130 may directly transmit the engine oil management data to the network service 120 by associating the data with the vehicle's pseudonymous identifier. In some embodiments, the process (3) can be an optional process.

At (4), the individual vehicles can transmit vehicle data with the generated pseudonymous identifiers to the network service. Although illustrated as a single transmission, the collection and transmission of vehicle data with associated pseudonymous identifiers can correspond to multiple transmissions. These transmissions may be scheduled on an individual vehicle basis or for groups of vehicles. Additionally, although the transmissions are illustrated as being transmitted in parallel, a vehicle may be triggered to transmit vehicle data to the network service at various times or in response to triggering criteria, such as experiencing errors, specific sensor values, accumulation of threshold amounts of vehicle data, changes in vehicle data values, and the like. At (4), the network service process the vehicle with the pseudonymous identifier. Illustratively, the network service can utilize the instantiated records, data stores, etc. associated with the previously transmitted pseudonymous identifier and without further association with other identification information associated with the vehicle, such as a VIN or user identifiers. Accordingly, the network service can illustratively receive detailed information about vehicles, including performance or operational parameters without having the necessary information to identify a particular vehicle or vehicle owner as providing (or associated with) the transmitted vehicle data.

In some embodiments, when the network connection between the vehicles 110 and the network service 120 is severed or disrupted, the computing device 130 can transmit the synchronized vehicle data to the network service 120. For example, the computing device 130 and vehicles 110 can be periodically synchronized with the vehicle data by utilizing the network 160, such as a short-range data communication network. In this example, if the vehicles 110 cannot connect to the network 150, the computing device 130 may transmit the vehicle data to the network service 120.

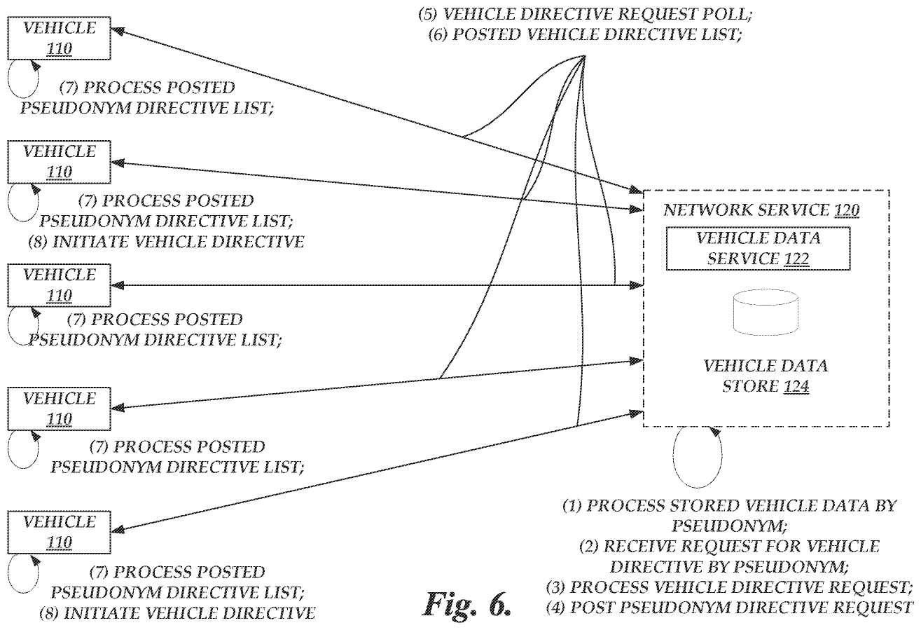

Turning now to FIG. 6, an illustrative interaction between the network service 120 and an individual one of the vehicles 110 for transmission of vehicle directives according to one or more pseudonymous identifiers will be described. As described above, although a set of interactions are illustrated, the present application is not limited to any particular number of vehicles 110 interacting with the network service 120. Rather, in some embodiments, the number of interactions between individual vehicles 110 and the network service 120 will be a relatively large scale including and exceeding thousands of individual vehicles.

At (1), the network service 120 can process (or receive requests to process) the stored vehicle data by pseudonym. In one embodiment, the network service 120 can analyze collected performance data to identify one or more actions that should be implemented by vehicles 110 associated with the pseudonymous identifiers. For example, the network service 120 can implement diagnostic processes that identify potential hardware or software errors/failures indicated by the collected vehicle data. In another example, the network service 120 can utilize processing techniques that facilitate the grouping or organization of sets of vehicles 110 based on vehicle data, such as operational parameters, vehicle attributes, regions of operations, characterizations of use, and the like. In some embodiments, the processing of the stored vehicle data may be omitted or implemented as a separate process and is not required herein.

At (2), the network service 120 receives a request for issuance of a vehicle directive by pseudonym. Illustratively, a vehicle directive corresponds to one or more actions and associated parameters that will be elicited by a vehicle upon receipt In one aspect, directives can include commands that are executed by the vehicle in response, such as diagnostic, repair or updating processes. The one or more actions may be considered mandatory or optional. In another aspect, the vehicle directives can include requests to elicit behavior by a vehicle owner/user, such as the generation of notification for scheduling a service call.

In still another aspect, the vehicle directives can include requests/commands for transmission of additional or supplemental vehicle data to the network service 120 or a third party. For example, the vehicle directive can include the transmission of identification information for a particular vehicle (e.g., VIN) and specific operational parameters that can utilize for subsequent actions by the network service 120. In such responsive communications, the pseudonymous identifier may be omitted such that the network service 120 cannot associate the supplementally provided vehicle identifiers with the pseudonymous identifier.

In a variation of the above, the vehicle directive may include a list of specific vehicles that the network service 120 is interested in tracking as a subset of pseudonymous identifiers. Accordingly, the vehicle directive may request a return of a pseudonymous identifier in responsive to a matching VIN. In this regarding, if the subset of pseudonymous identifiers is sufficiently large, the service provider will not be able to determinatively associate any particular VIN to a pseudonymous identifier.

At (3), the network service 120 processes the vehicle directive request. In one aspect, the network service 120 can validate that the request for vehicle data is permitted, such as via authentication or authorization mechanisms. In another aspect, the received request may not explicitly identify the pseudonymous identifiers of interest but provides selection criteria (e.g., all vehicles having a mileage exceeding 100,000 miles). Accordingly, the network service 120 can query the stored vehicle data to identify the appropriate pseudonymous identifiers correlated to the selection criteria. In still another aspect, if selection criteria result in a set of pseudonymous identifiers that do not exceed a size threshold, the network service 120 can reject the request, ask for additional criteria, or include additional pseudonymous identifiers to the set. As described previously, having a set of pseudonymous identifiers exceeding one or more thresholds can mitigate the potential network service 120, individual or third party can iteratively match a VIN or other identification information with a specific pseudonymous identifier.

At (4), the network service 120 can post the vehicle directive request that identifies a set of pseudonymous identifiers that have been requested to implement the directive request. In this embodiment, the network service 120 does not need to actively transmit the vehicle directive requests to each vehicle or include processing mechanisms that specifically identify contact mechanisms (e.g., network addresses) for each pseudonymous identifier. Rather, individual vehicles will independently contact the network service 120 for the published list of pseudonymous identifiers and vehicle directives.

At (5), the individual vehicles 110 request the posted vehicle directives with the list of pseudonym identifiers. Illustratively, the individual vehicles do not need to be configured to transmit the request at the same time. The transmission of the request can be randomized or implemented with a range of times (e.g., anytime throughout a day) such that the transmission of requests can be distributed in a manner to lessen the requirements for network processing resources by the network service 120. At (6), the network service 120 can respond individually to each request. In one embodiment, the network service 120 can provide the published/posted vehicle directives and associated set of pseudonymous identifiers. This can include an identification of the full list of pseudonymous identifiers or some sorted/filtered subset of pseudonymous identifiers. This approach requires the vehicle 110 to be able to match a pseudonymous identifier with the list of pseudonymous identifiers. In another embodiment, the vehicle may transmit the pseudonymous identifier(s) of interest and the network service 120 can then determine whether a match occurs. The network service 120 can then respond with a notification or confirmation. This embodiment can minimize the amount of data transmitted between the network service 120 and the vehicle and also reduce the impact on the vehicle's processing resources to process a list to identify potential matches.

At (7), the vehicles 110 (such as via a management component 210) can collect and process the published/posted vehicle directives and associated set of pseudonymous identifiers. As described above, the vehicles process the published/posted vehicle directives and associated set of pseudonymous identifiers by attempting to match the vehicle's specific pseudonymous identifier with any of the pseudonymous identifiers includes associated with the vehicle directive. If the vehicle does not match the vehicle's specific pseudonymous identifier, the vehicle directive can be disregarded. Alternatively, as illustrated in FIG. 6, for a subset of a vehicle matching a pseudonymous identifier, the vehicle can initiate or otherwise process the vehicle directive. As described above, the initiation of the vehicle directive can elicit a number of responsive actions by the vehicle. In one aspect, directives can include commands that are executed by the vehicle in response, such as diagnostic, repair or updating processes. The one or more actions may be considered mandatory or optional. In another aspect, the vehicle directives can include requests to elicit behavior by a vehicle owner/user, such as the generation of notification for scheduling a service call. Still further, the vehicle can also transmit confirmations, status, or notifications as requested or if the vehicle is preconfigured to transmit confirmation, status or notification communications.

At (8), the vehicles 110 may initiate the vehicle directive. In some embodiments, the vehicles 110, by processing the directives, categorizes the directives based on priority, type of required action (e.g., mandatory, optional, urgent, etc.), etc. The vehicles 110 may further provide one or more instruction or recommendations to the vehicle owner or driver based on the processing result of the directives.

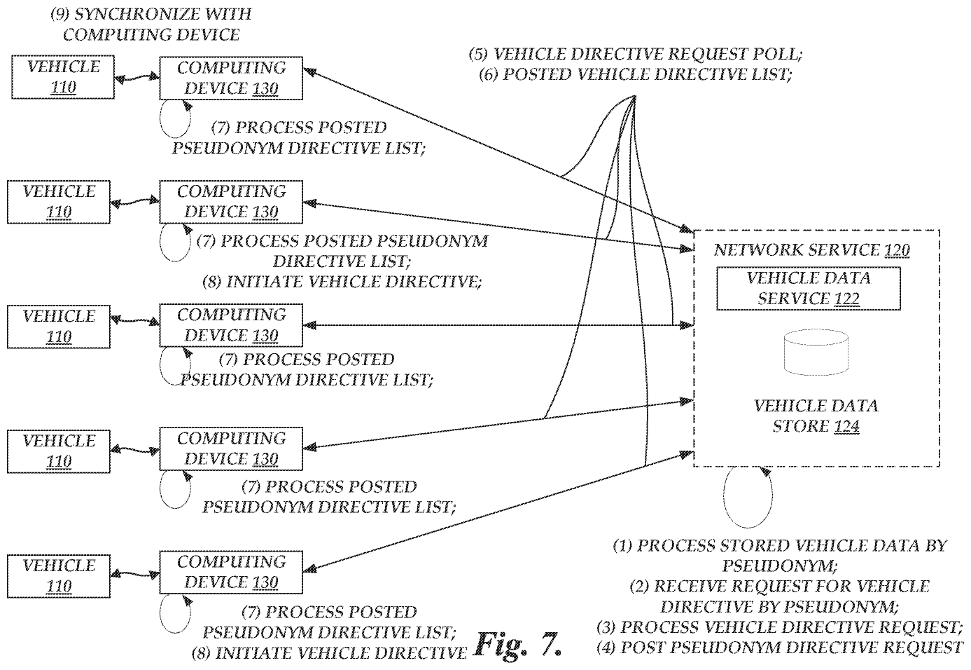

Turning now to FIG. 7, an illustrative interaction of an alternative embodiment between the network service 120 and a computing device 130 for transmission of vehicle directives according to one or more pseudonymous identifiers will be described. As described above, although a set of interactions are illustrated, the present application is not limited to any particular number of vehicles 110 and computing device 130 interacting with the network service 120. Rather, in some embodiments, the number of interactions between individual vehicles 110 and the network service 120 will be a relatively large scale including and exceeding thousands of individual vehicles. The processes of (1)-(4) as described in FIG. 6 can be used in FIG. 7.

At (5), the computing device 130 may request the posted vehicle directives with list of pseudonym identifiers. Illustratively, the computing device 130 do not need to be configured to transmit the request at the same time. The transmission of the request can be randomized or implemented with a range of times (e.g., anytime throughout a day) such that the transmission of requests can be distributed in a manner to lessen the requirements for network processing resources by the network service 120. At (6), the network service 120 can respond individually to each request. In one embodiment, the network service 120 can provide the published/posted vehicle directives and associated set of pseudonymous identifiers. This can include an identification of the full list of pseudonymous identifiers or some sorted/filtered subset of pseudonymous identifiers. This approach requires the vehicle 110 to be able to match a pseudonymous identifier with the list of pseudonymous identifiers. In another embodiment, the computing device 130 may transmit the pseudonymous identifier(s) of interest, and the network service 120 can then determine whether a match occurs. The network service 120 can then respond with a notification or confirmation. This embodiment can minimize the amount of data transmitted between the network service 120 and the computing device 130 and also reduce the impact on the computing device's 130 processing resources to process a list to identify potential matches.

At (7), the computing device 130 can collect and process the published/posted vehicle directives and associated set of pseudonymous identifiers. As described above, the computing device 130 processes the published/posted vehicle directives and associated set of pseudonymous identifiers by attempting to match the vehicle's specific pseudonymous identifier with any of the pseudonymous identifiers includes associated with the vehicle directive. If the computing device 130 does not match the vehicle's specific pseudonymous identifier, the vehicle directive can be disregarded. Alternatively, as illustrated in FIG. 7, for a subset of vehicles matching a pseudonymous identifier, the computing device 130 can initiate or otherwise process the vehicle directive. As described above, the initiation of the vehicle directive can elicit a number of responsive actions by the computing device 130. In one aspect, directives can include commands that are executed by the computing device 130 in response, such as diagnostic, repair, or updating processes. The one or more actions may be considered mandatory or optional. In another aspect, the vehicle directives can include requests to elicit behavior by a vehicle owner/user, such as the generation of a notification for scheduling a service call. Still, further, the vehicle can also transmit confirmations, status, or notifications as request or if the vehicle is preconfigured to transmit confirmation, status, or notification communications.

At (8), the computing device 130 may initiate the vehicle directive. In some embodiments, the computing device 130, by processing the directives, categorizes the directives based on priority, type of required action (e.g., mandatory, optional, urgent, etc.), etc. The computing device 130 may further provide one or more instructions or recommendations to the vehicle owner or driver based on the processing result of the directives.

At (9), the computing device 130 may synchronize the vehicle data, such as updated vehicle data based on processing the directives, with the vehicle 110.

In alternative embodiments, both vehicles 110 and computing device 130 may respond to the directives posted by the network service 120. In this embodiment, the network service 120 may establish the initial communication path between the vehicle and the network service based on criteria. The criteria can be based on the timing of the response received at the network service 120 (such as network request component 358). For example, if the network request component 358 receives a response from the vehicle before the computing device, the network request component 358 may establish the initial communication path between the vehicle and the network service. The criteria also can be based on network performance monitoring results. For example, the network request component 358 may compare the network performances of the network connection with the vehicle and computing device.

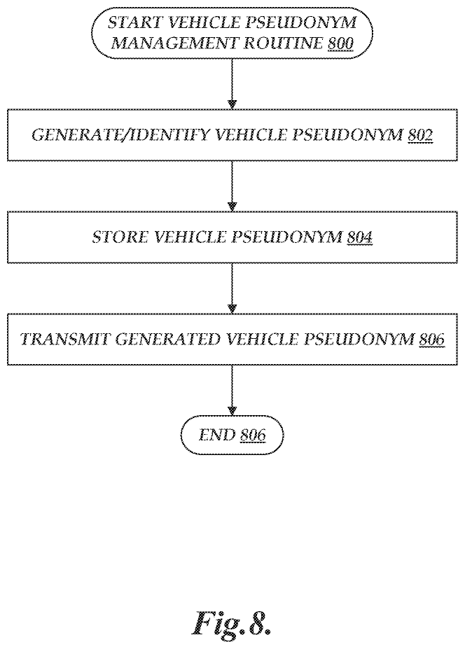

Turning now to FIG. 8, a routine 800 for a vehicle pseudonym management routine 800 will be described. Routine 800 is illustratively implemented by the management component 210 implemented in one of the vehicles 110. The processes illustrated in FIG. 8 are illustrative in nature and should not be construed as limiting.

At block 802, the vehicles 110 (such as via a management component 210) can generate or configure pseudonymous identifier(s) that will be utilized to identify an individual one of the vehicles 110 by the network service 120. As described above, the pseudonymous identifier can correspond to any one of a variety of unique or semi-unique identifier. The pseudonymous identifier may be based on attributes of one of the particular vehicles 110, such as the representation of specific hardware or software components. In another example, a pseudonymous identifier may be selected from a list of available pseudonymous identifiers, such as random selection. The generation or configuration of the pseudonymous identifier(s) may take place at the time of manufacture, release from the manufacturer, and the like.

At block 804, the vehicles 110 can store the pseudonymous identifiers in a local memory for use in communications. The pseudonymous identifies may be associated with encryption mechanisms or other security mechanism to prevent modification or corruption of the pseudonymous identifier by a user or external service.

At block 806, the individual vehicles 110 can transmit the generated pseudonym with the network service 120 (such as vehicle data service 122). This process illustrates the first instantiation of the transmission of pseudonymous identifiers between the vehicles 110 and the network service 120. Although the transmissions are illustrated as being transmitted in parallel, one of the vehicles 110 may be triggered to register with the network service 120 at various times or in response to triggering criteria, such as the delivery of the vehicle to a new owner. In some embodiments, the timing of transmission of the pseudonym may be based on a seed value, such as a randomly generated number, so that the transmission of the pseudonyms does not closely relate to the delivery of the vehicle or timing of the generation of the pseudonym. At block 806, routine 800 can be ended.

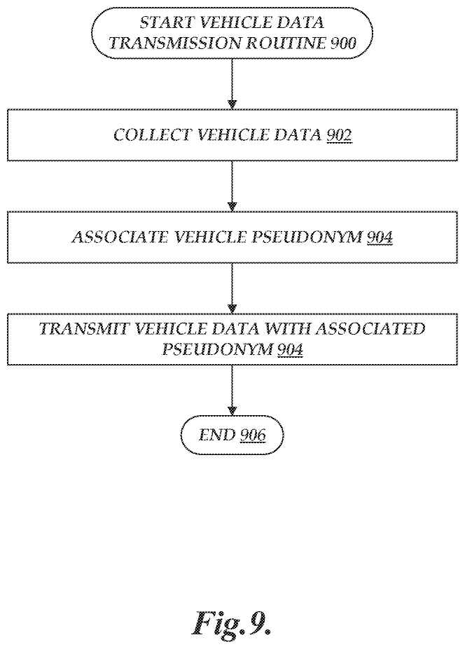

Turning now to FIG. 9, a routine 900 for a vehicle data transmission routine 900 will be described. Routine 900 is illustratively implemented by the management component 210 implemented in one of the vehicles 110. The processes illustrated in FIG. 9 are illustrative in nature and should not be construed as limiting.

At block 902, the vehicles 110 (such as via a management component 210) can collect vehicle data. As described above, the vehicles include a plurality of sensors, components, and data stores for obtaining, generating, and maintaining vehicle data, including operational data. The collection and processing of vehicle data may be based on programed configuration data, manual input from a user, or responsive to requests from the network service (not illustrated).

At block 904, the vehicles 110 can associate the previously stored pseudonymous identifiers maintained in a local memory. The pseudonymous identifies and vehicle data may be associated with encryption mechanisms or other security mechanism to prevent modification or corruption of the pseudonymous identifier by a user or external service.

In some embodiments, one or more of the vehicles 110 may synchronize the vehicle data with the computing device 130. In some embodiments, the synchronization can be performed periodically or in real time. In some embodiments, a part of data can be synchronized with the computing device 130. In these embodiments, the part of data can be defined or designated by a user, vehicle manufacturer, vehicle administrator, etc. For example, the computing device 130 only get synchronized vehicle data related to engine oil management data. In this example, the computing device 130 may directly transmit the engine oil management data to the network service 120 by associating the data with the vehicle's pseudonymous identifier. In some embodiments, the process (3) can be an optional process.

At block 904, the individual vehicles can transmit vehicle data with the generated pseudonymous identifiers to the network service. Although illustrated as a single transmission, the collection and transmission of vehicle data with associated pseudonymous identifiers can correspond to multiple transmissions. These transmissions may be scheduled on an individual vehicle basis or for groups of vehicles. Additionally, although the transmissions are illustrated as being transmitted in parallel, a vehicle may be triggered to transmit vehicle data to the network service at various times or in response to triggering criteria, such as experiencing errors, specific sensor values, accumulation of threshold amounts of vehicle data, changes in vehicle data values, and the like.

In some embodiments, when the network connection between one of the vehicles 110 and the network service 120 is severed or disrupted, the computing device 130 can transmit the synchronized vehicle data to the network service 120. For example, the computing device 130 and one of the vehicles 110 can be periodically synchronized the vehicle data by utilizing the network 160, such as a short range data communication network. In this example, if a vehicle cannot connect to the network 150, the computing device 130 may transmit the vehicle data to the network service 120. The routine 900 can be ended at block 906.

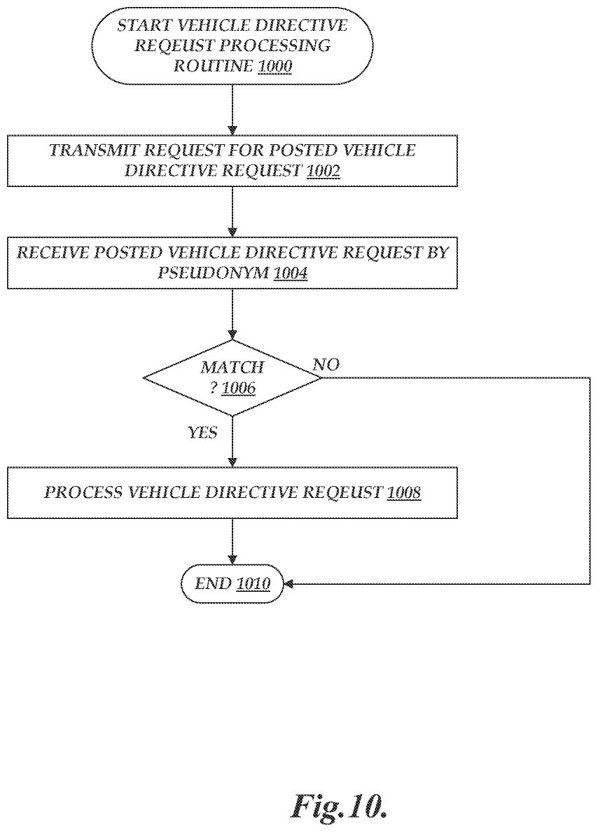

Turning now to FIG. 10, a routine 1000 for a vehicle directive request processing routine 1000 will be described. Routine 1000 is illustratively implemented by the management component 210 implemented in one of the vehicles 110. The processes illustrated in FIG. 10 are illustrative in nature and should not be construed as limiting.

At block 1002, the individual vehicles 110 request the posted vehicle directives with list of pseudonym identifiers. Illustratively, the individual vehicles do not need to be configured to transmit the request at the same time. The transmission of the request can be randomized or implemented with a range of times (e.g., anytime throughout a day) such that the transmission of requests can be distributed in a manner to Jessen the requirements for network processing resources by the network service 120.

At block 1004, the vehicles 110 (such as via a management component 210) can receive the published/posted vehicle directives and associated set of pseudonymous identifiers. At block 1006, the vehicles 110 processes the published/posted vehicle directives and associated set of pseudonymous identifiers by attempting to match the vehicle's specific pseudonymous identifier with any of the pseudonymous identifiers includes associated with the vehicle directive. If the vehicle does not match the vehicle's specific pseudonymous identifier, the routine 1000 can be ended at block 1010, and the vehicle directive can be disregarded. If the vehicle match the vehicle's specific pseudonymous identifier, the routine continues to block 1008. In some embodiments, for a subset of vehicle matching a pseudonymous identifier, a vehicle can initiate or otherwise process the vehicle directive. In these embodiments, the initiation of the vehicle directive can elicit a number of responsive actions by the vehicle. In one aspect, directives can include commands that are executed by the vehicle in response, such as diagnostics, repairs, or updating processes. One or more actions may be considered mandatory or optional. In another aspect, the vehicle directives can include requests to elicit behavior by a vehicle owner/user, such as generation of notification for scheduling a service call. Still, further, the vehicle can also transmit confirmations, status, or notifications as requested or if the vehicle is preconfigured to transmit confirmation, status, or notification communications

At block 1008, the vehicles 110 may initiate the vehicle directive. In some embodiments, the vehicles 110, by processing the directives, categorizes the directives based on priority, type of required action (e.g., mandatory, optional, urgent, etc.), etc. The vehicles 110 may further provide one or more instructions or recommendations to the vehicle owner or driver based on the processing result of the directives.

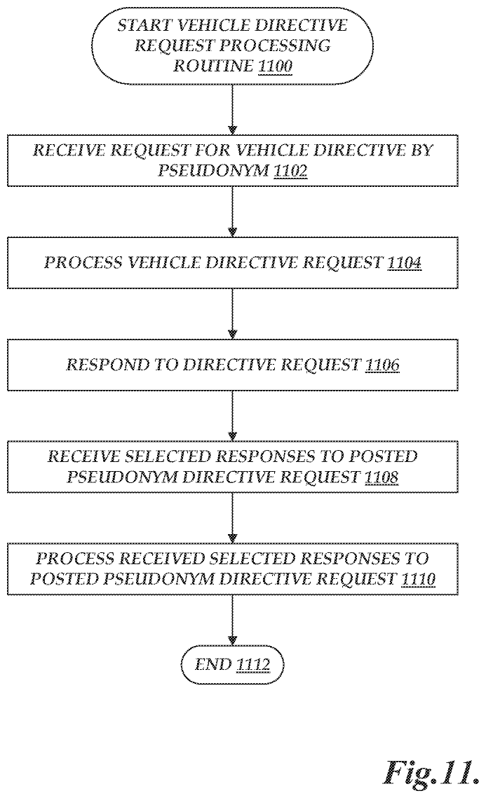

Turning now to FIG. 11, a routine 1100 for a vehicle directive request processing routine 1100 will be described. Routine 1100 is illustratively implemented by the vehicle data service 122 implemented in the network service 120. The processes illustrated in FIG. 10 are illustrative in nature and should not be construed as limiting.

At block 1102, the network service 120 receives a request for issuance of a vehicle directive by pseudonym. Illustratively, a vehicle directive corresponds to one or more actions and associated parameters that will be elicited by a vehicle upon receipt. In one aspect, directives can include commands that are executed by the vehicle in response, such as diagnostic, repair or updating processes. One or more actions may be considered mandatory or optional. In another aspect, the vehicle directives can include requests to elicit behavior by a vehicle owner/user, such as the generation of notification for scheduling a service call.

In still another aspect, the vehicle directives can include requests/commands for transmission of additional or supplemental vehicle data to the network service 120 or a third party. For example, the vehicle directive can include the transmission of identification information for a particular vehicle (e.g., VIN) and specific operational parameters that can utilize for subsequent actions by the network service 120. In such responsive communications, the pseudonymous identifier may be omitted such that the network service 120 cannot associate the supplementally provided vehicle identifiers with the pseudonymous identifier.

In a variation of the above, the vehicle directive may include a list of specific vehicles that the network service 120 is interested in tracking as a subset of pseudonymous identifiers. Accordingly, the vehicle directive may request a return of a pseudonymous identifier in response to a matching VIN. In this regard, if the subset of pseudonymous identifiers is sufficiently large, the service provider will not be able to determinatively associate any particular VIN to a pseudonymous identifier.

In some embodiments, the network service 120 can process (or receive requests to process) the stored vehicle data by pseudonym. In one embodiment, the network service 120 can analyze collected performance data to identify one or more actions that should be implemented by vehicles 110 associated with the pseudonymous identifiers. For example, the network service 120 can implement diagnostic processes that identify potential hardware or software errors/failures indicated by the collected vehicle data. In another example, the network service 120 can utilize processing techniques that facilitate the grouping or organization of sets of vehicles 110 based on vehicle data, such as operational parameters, vehicle attributes, regions of operations, characterizations of use, and the like In some embodiments, the processing of the stored vehicle data may be omitted or implemented as a separate process and is not required herein.

At block 1104, the network service 120 processes the vehicle directive request. In one aspect, the network service 120 can validate that the request for vehicle data is permitted, such as via authentication or authorization mechanisms. In another aspect, the received request may not explicitly identify the pseudonymous identifiers of interest but provides selection criteria (e.g., all vehicles having a mileage exceeding 100,000 miles). Accordingly, the network service 120 can query the stored vehicle data to identify the appropriate pseudonymous identifiers correlated to the selection criteria. In still another aspect, if selection criteria result in a set of pseudonymous identifiers that do not exceed a size threshold, the network service 120 can reject the request, ask for additional criteria or include additional pseudonymous identifiers to the set. As described previously, having a set of pseudonymous identifiers exceeding one or more thresholds can mitigate the potential network service 120, individual or third party can iteratively match a VIN or other identification information with a specific pseudonymous identifier.

At block 1106, the network service 120 can respond individually to each request. In one embodiment, the network service 120 can provide the published/posted vehicle directives and associated set of pseudonymous identifiers. This can include an identification of the full list of pseudonymous identifiers or some sorted/filtered subset of pseudonymous identifiers. This approach requires a vehicle to be able to match a pseudonymous identifier with the list of pseudonymous identifiers.

At block 1108, the network service 120 can receive selected responses to posted pseudonym directive request. In some embodiments, a vehicle may transmit the pseudonymous identifier(s) of interest, and the network service 120 can then determine whether a match occurs. In some embodiments, the network service 120 can then respond with a notification or confirmation. This embodiment can minimize the amount of data transmitted between the network service 120 and the vehicle and also reduce the impact on the vehicle's processing resources to process a list to identify potential matches.

At block 1110, the network service 120 can process the received selected responses to posted the vehicle directive request that identifies a set of pseudonymous identifiers that have been requested to implement the directive request. In this embodiment, the network service 120 does not need to actively transmit the vehicle directive requests to each vehicle or include processing mechanisms that specifically identify contact mechanisms (e.g., network addresses) for each pseudonymous identifier. Rather, individual vehicles will independently contact the network service 120 for the published list of pseudonymous identifiers and vehicle directives. The routine 1100 can be ended at block 1112.

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected actions or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program. In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments may not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated the appended claims rather than by the foregoing description. All changes which come within the meaning and range of equivalency of the claims are to be embraced within their scope.

What is claimed:

1. A system for managing vehicle data by using pseudonymous identifiers associated with vehicles, the system comprising one or more external computing devices associated with a processor and a memory for executing computer-executable instructions to implement a management component, wherein the management component is configured to:
perform a pseudonyms configuration, wherein each of the pseudonymous identifiers is associated with an individual vehicle, and wherein the pseudonymous identifiers configuration comprises:
identifying a pseudonymous identifier;
storing the identified pseudonymous identifier; and
transmitting the identified pseudonymous identifier;
receive vehicle data transmission to a network service, wherein the vehicle data transmission comprises:
collecting the vehicle data;
associating the vehicle data with the identified pseudonymous identifier; and
transmitting the vehicle data with the identified pseudonymous identifier to the network service; and
request vehicle directives from the network service, wherein the requesting vehicle directives comprises:
transmitting to the network service to post vehicle directives;
receiving the posted vehicle directives;
identifying at least one directive related to the vehicle; and
initiating the identified directive.

2. The system as recited in claim 1, wherein the vehicle directives include commands that are executed by the vehicle in a response to identifying the vehicle directives associated with the vehicle, such as diagnostics, repairs, or updating processes.

3. The system as recited in claim 1, wherein the pseudonymous identifier is corresponding to one of variety of unique or semi-unique identifier associated with the individual vehicle.

4. The system as recited in claim 1, wherein the individual vehicle includes a plurality of sensors, components, and data stores for obtaining, generating, and maintaining the vehicle data.

5. The system as recited in claim 1, wherein the management component is further configured to synchronize the vehicle data with a computing device, and wherein the computing device is configured to communicate the vehicle data wirelessly.

6. The system as recited in claim 5, wherein the computing device is configured to transmit the vehicle data to the network service.

7. The system as recited in claim 1, wherein the posted vehicle directives is publishing the vehicle directives and associated set of pseudonymous identifiers.

8. The system as recited in claim 1, wherein the network service is configured to:
receive a request for an issuance of the vehicle directives by the pseudonym identifiers;
process the request for the vehicle directives by identifying appropriate pseudonymous identifiers correlated to selection criteria, wherein the selection criteria is associated with a threshold of vehicle attributes, and wherein the vehicle directives associated with the appropriate pseudonymous identifiers are posted vehicle directives; and
provide the posted vehicle directives to the management component.

9. A system for managing vehicle data by using pseudonymous identifiers associated with vehicles, the system comprising:
identifying a pseudonymous identifier associated with a vehicle;
transmitting the vehicle data with the identified pseudonymous identifier to a network service;
receiving posted vehicle directives from the network service;
identifying at least one directive related to the vehicle; and
initiating the identified directives.

10. The system as recited in claim 9, wherein the vehicle directives include commands that are executed by the vehicle in a response to identifying the vehicle directives associated with the vehicle, such as diagnostics, repairs, or updating processes.

11. The system as recited in claim 9, wherein the pseudonymous identifier is corresponding to one of variety of unique or semi-unique identifier associated with the individual vehicle.

12. The system as recited in claim 1 further comprising synchronizing the vehicle data with a computing device, wherein the computing device is configured to communicate the vehicle data.

13. The system as recited in claim 12, wherein the computing device is configured to transmit the vehicle data to the network service.

14. The system as recited in claim 9, wherein the posted vehicle directives is publishing the vehicle directives and associated set of pseudonymous identifiers.

15. The system as recited in claim 9, wherein the network service is configured to:
receive a request for an issuance of the vehicle directives by the pseudonym identifiers;
process the request for the vehicle directives by identifying appropriate pseudonymous identifiers correlated to selection criteria, wherein the selection criteria is associated with a threshold of vehicle attributes, and wherein the vehicle directives associated with the appropriate pseudonymous identifiers are posted vehicle directives; and
provide the posted vehicle directives to the vehicles.

16. A computer-implemented method for providing managing vehicle data by using pseudonymous identifiers associated with vehicles, the method comprising:
identifying a pseudonymous identifier associated with an individual vehicle;
storing the identified pseudonymous identifier;
transmitting the identified pseudonymous identifier to a network service;
associating the vehicle data with the identified pseudonymous identifier;
transmitting the vehicle data with the identified pseudonymous identifier to the network service;
transmitting to the network service to post vehicle directives;
receiving the posted vehicle directives;
identifying at least one directive related to the vehicle; and
initiating the identified directive.

17. The computer-implemented method of claim 16, wherein the vehicle directives include commands that are executed by the vehicle in a response to identifying the vehicle directives associated with the vehicle, such as diagnostics, repairs, or updating processes.

18. The computer-implemented method of claim 16, wherein the pseudonymous identifier is corresponding to one of variety of unique or semi-unique identifier associated with the individual vehicle.

19. The computer-implemented method of claim 16, wherein the individual vehicle is further configured to synchronize the vehicle data with a computing device, and wherein the computing device is configured to communicate the vehicle data wirelessly.

20. The computer-implemented method of claim 19, wherein the computing device is configured to transmit the vehicle data to the network service.

21. The computer-implemented method of claim 16, wherein the network service is configured to:
receive a request for an issuance of the vehicle directives by the pseudonym identifiers;
process the request for the vehicle directives by identifying appropriate pseudonymous identifiers correlated to selection criteria, wherein the selection criteria is associated with a threshold of vehicle attributes, and wherein the vehicle directives associated with the appropriate pseudonymous identifiers are posted vehicle directives; and
provide the posted vehicle directives to the individual vehicle.
